(19) United States
(12) Patent Application Publication
(10) Pub. No.: US 2025/0315703 A1
(43) Pub. Date: Oct. 9, 2025

(54) method of interagent communication in probabilistic agents implementing factor graph document databases

(71) Applicant: Verses AI, Inc., New Westminster (CA)

(72) Inventors: Ozan Catal, Ghent (BE); Mahault Albarracin, Montreal (CA); Riddhi Jain Pitliya, Oxford (GB); Tim Verbelen, Dendermonde (BE)

(21) Appl. No.: 19/095,775

(22) Filed: Mar. 31, 2025

Related U.S. Application Data
(60) Provisional application No. 63/631,184, filed on Apr. 8, 2024.

(51) Int. Cl. G06N 7/01; G06F 16/901

(52) U.S. Cl. CPC G06N 7/01; G06F 16/9024

(57) ABSTRACT

A method of interagent communication in probabilistic agents using factor graph document databases wherein multiple agents reach a consensus on the probabilistic structure of the environment in which they perform their tasks using factor graph document databases implemented by said agents, and updating a conditional probability matrix for each agent using an update method, and sharing the updates using a sharing method involving matrix multiplication of the conditional probability matrices.

### FIELD OF INVENTION

This invention concerns the field of artificial intelligence agent communication.

### BACKGROUND

Artificial Intelligence Agents are pieces of software code that can be implemented in devices of different kinds (e.g., a robot) to enable appropriate device behavior and decision making (e.g., fetching a box in a warehouse). For purposes of this application, the term device and robot are used to define a physical or virtual robot or other device that acts in an environment to accomplish a task. An agent defines the software controlling the device in order to accomplish the task. Interagent communication (IC) is the process whereby two agents share information so as to accomplish their tasks more efficiently (e.g., making sure that in searching for a box no more than one robot is going to the same place). IC involves sharing information across all the communicating agents and deciding upon what to do with the information. Methods of IC are of two kinds: (i) deterministic IC, or (ii) probabilistic IC.

In deterministic IC, the information is shared in a way that enables agents to discard the information in one agent of the group and only preserve the information of another agent in the group. For instance, if an agent AG1 finds the box at location (L1), then agents AG2 and AG3 will discard the non-L1 locations as locations where the box could be found.

In probabilistic agents, information is shared in a way that enables them to hold probabilistic beliefs about information (e.g., the box is more probably in L1 than in L2). The knowledge shared across all the agents can be based, for instance, on the number of agents having observed the boxes at different locations (e.g., ⅔ of the agents have observed boxes in L1, and ⅓ in L2, such that the probability of the box being at L1 is ⅔ and the probability of the box being at location L2 is ⅓). Probabilistic IC is useful when agents have to navigate a dynamic environment that may change as a function of factors that are not under their control, or about which they do not have information (e.g., if a warehouse worker moves a box without registering the information in the warehouse management system). However, probabilistic IC is difficult to achieve since, to obtain efficient coordination between all agents, it requires a consensus on the probabilities of events to occur in the environment.

### BRIEF DESCRIPTION OF THE DRAWINGS

FIG. 1 is a depiction of the structure of a simple prior art graph database as known in the art;

FIG. 2 is a depiction of the structure of a computation graph database as known in the art;

FIG. 3 is a depiction of the structure of a factor graph document database treated as a computation graph database, as known in the art;

FIG. 4 illustrates a flowchart of one embodiment of the invention;

FIG. 5 depicts one implementation of the process of an update method and a sharing method to reach a consensus.

### SUMMARY OF THE INVENTION

The claimed method of interagent communication in probabilistic agents involves implementing factor graph document databases, which enables multiple agents to reach consensus on the probabilistic structure of the environment in which they perform their tasks. The claimed method uses a factor graph document database with computational capabilities—defined below—that defines an agent's model and that stores information about the agent's environment and that updates the agent's probabilistic beliefs about the structure of the environment upon receipt of novel information and that shares the consensus about that information between all agents involved in a task.

### Definitions

### Factor Graph Document Database

Databases are queryable data stores. The three common classes of databases are relational databases, graph databases, and vector databases. Compared to relational and vector databases, graph databases store data in a way that allows for querying by looking at parent-child relationships between the stored entities (e.g., “give me the child entities to the Steve entity”). Graph databases can represent entities in the world and the relationships between them. Entities are any physical or conceptual “thing” that has meaning in the real world (e.g., a robot, a sofa, a waypoint in space that refers to a location where one can go, a specification of an activity, etc.). Relationships between entities are expressed as edges that connect source nodes (e.g., the parent or cause nodes) and the destination nodes (e.g., the children or the consequence node), and that can give cause-consequence, or parent-child information.

A vector graph document database is a queryable data store. Vector graph document databases are databases whose structure allows for mix queries combining relational, graph, and vector databases type queries (e.g., “give me the products whose prices are greater than 5 dollars and that are sold by the company X, and whose description best matches that of sunglasses”).

A computation graph database is a graph database for a computation graph. The computation graph is a directed graph, which includes source and destination nodes that represent variables, and further includes edges representing transformations in the value of a destination node that can occur when an update happens to a connected source node. The terms “entity”, “node” and “variable” are used interchangeably. A computation graph database is thus a graph database that can be used to perform mathematical operations over the stored entities.

A factor graph is a type of probabilistic graphical model that can be used to perform inferences over the entities represented by the nodes in the graph. A factor graph consists of two types of nodes: (i) factor nodes, which represent factors or functions that relate multiple variables together (e.g., the function that multiplies the elements x1, x2, x3 . . . of a variable X with the elements y1, y2, y3 . . . of a variable Y), (ii) and variable nodes, which represent the variables in the model. For the factor graphs used in this invention, we use a bipartite graph representation and partition the graph into factor nodes and variable nodes. The factor nodes are connected to the variable nodes that they depend on, and the graph structure reflects the conditional dependencies between the variables. Variable nodes are denoted by circles and correspond to variables over which the inference algorithm applies. Variable nodes are entities of the vector graph document database. Factor nodes are denoted by squares and denote the relation between variables, or entities.

A factor graph document database is a type of computation graph database that uses a factor graph to implement a vector graph document database over which factor graph operations such as message passing can be performed. Factor graph operations allow the inference of values of any desired nodes in the vector graph document database. Thus, factor graph document databases are computation graph databases structured as factor graphs, and that are able to perform factor graph operations such as message passing.

The code for the claimed method of interagent communication in probabilistic agents, which are implemented as factor graph document databases may be implemented as a class in the Python programming language and is composed of an update method that updates the beliefs of individual agents upon receipt of novel information, and a sharing method that combines the information of all the agents to reach a consensus about the probabilistic structure of the environment.

### DETAILED DESCRIPTION

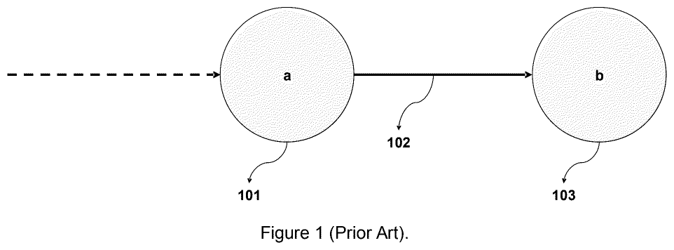

FIG. 1 illustrates the structure of a simple prior art graph database with two nodes: source node 101, and destination node 103, related to each other by an edge 102. A graph database gives parent-child information about the entities (which are defined by the nodes) contained in the database. The graph database represents parent-child information by using edge 102 relating the source entity 101 and the destination entity 103.

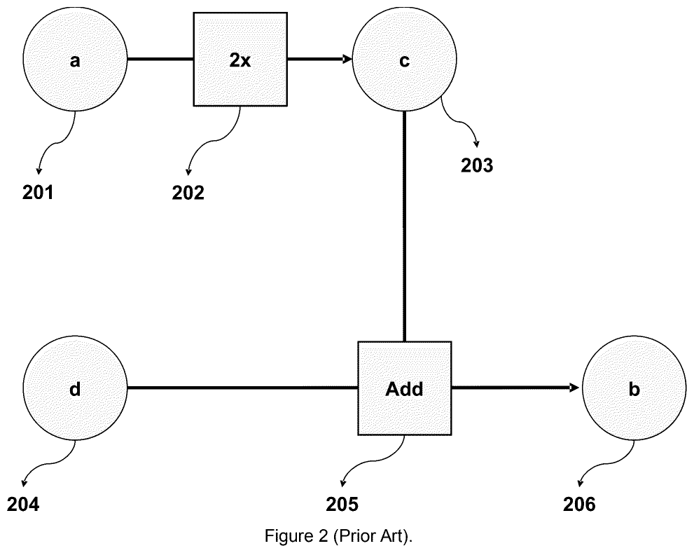

FIG. 2 illustrates the structure of a prior art computation graph database performing a mathematical operation “b=2a+d” over the source node “a” and a destination node “b”. The update rule is represented as a mathematical operation whose description is encoded in the graph database (e.g., operations represented as squares in FIG. 2 operating on factor nodes and intermediary nodes) and operated through a call to a programming language. In FIG. 2, this is defined by source node “a” (201) being subjected to a multiplication operation 202 to define interim node 203. Node “” (204) is added by “Add” operation 205 to the value of interim node 203 to define destination node “b” (206). The function of a computation graph database is to update a destination node (e.g., b) when a change in a source node (e.g., a) happens. When a change in entity “a” (201) is observed, the value of the entity “b” (206) is updated. The update rule is operated through two transforms, which are transform 202, which calculates two times the value of “a” (2a) to define variable “c” 203, and transform 205, which adds variable “c” to variable “d” 204 to update variable “b” 206. This operation thus requires an intermediary entity “c” 203 that is constructed for the purposes of evaluating the expression operated by the transform in 205.

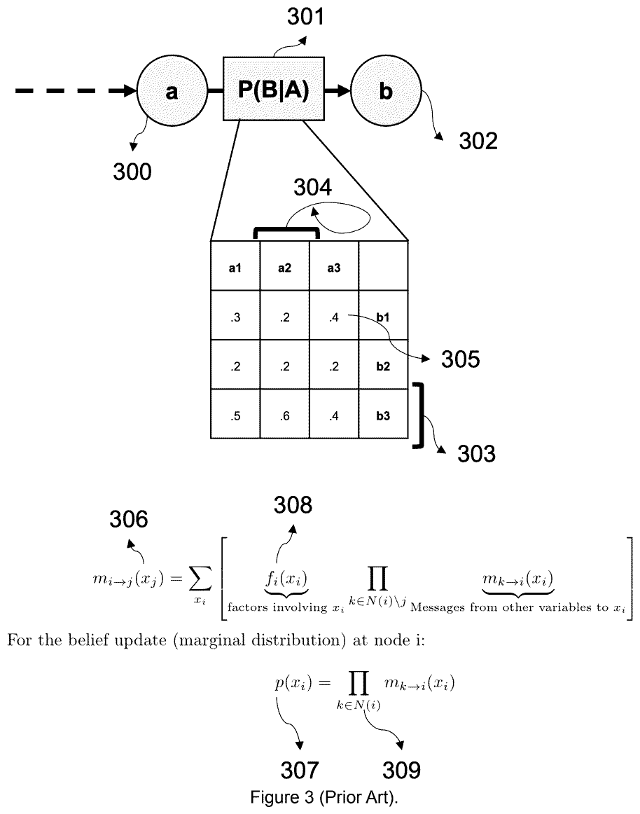

FIG. 3 shows the structure of a factor graph document database treated as a computation graph database. As a type of computation graph database, a factor graph database can perform operations such as message passing to update the variables stored in the database. The factor graph relates variables by means of nodes, in this case, a source node “a” (300) and a destination node “b” (302), and their relating factor encoding information 301 about the conditional probability of elements of the variable “b” relating to elements of the variable “a”.

The probabilities are presented as mappings in matrices (or in tensors). 304 indicates that the column of the matrix corresponds to a probability distribution (i.e., must sum to 1, e.g., 0.2+0.2+0.6). Each cell encodes a probabilistic mapping between the variable represented by the column (e.g., elements of the variable “a” such as a1, a2, a3) and the variable represented by the rows (e.g., elements of the variable “b” such as b1, b2, b3). Reference numeral 303 indicates the rows that represent the observed variable, or the children of an entity. Reference numeral 305 indicates that the probability of b1 being related to a3 is 40% (0.4). The mathematical operation performed by the factor graph database is an inference algorithm represented in the equation (306-309). The factor graph document database infers variables and elements automatically using programming language implementing a message passing algorithm as defined further below, upon the receipt of an element belonging to a destination node, the destination nodes functioning as inputs to a factor graph document database (e.g., when receiving “b2” as an input, inferring automatically what “A” element relates to it).

The algorithm is a message-passing algorithm that computes the message from node i (e.g., a) to node j (e.g., b). The message is defined as the summation of the product of the factor connecting the node of interest and the messages coming from other variable nodes, over all possible values of the entity i as encoded by the factor 306, N (i) referring to the set of neighboring nodes. 307 is the marginal probability of node i, 308 is the factor associated with node i, and 309 is the set of neighbors of node i. The inference method of the present invention uses a factor graph document database. The factor graph document database can also be trained directly based on observations using a method of updating by counts, which uses a computer program to add, for instance “+1” to a cell of the matrix that constitutes the factor. For instance, if a cell contains “0.4” (305), adding a count to the cell would mean raising the value of the cell to 1.4 (1+0.4). If the cell is part of a column that has three cells in total, which together form a distribution (e.g., 0.4, 0.2, 0.4,), then the column after the updated count would be “1.4; 0.2; 0.4”. The column gets renormalised such that its three cells sum to 1 (e.g., 1.4 becomes 0.7, 0.2 becomes 0.1, and 0.4 becomes 0.2). This method of adding counts trains the factor graph document database using observed data by adding +1 after observing the co-occurrence b1 and a3, which augments the probability of P(b1|a3) in the factor graph to 0.7 and decreases the probability of the two other mapping of the collum, bringing them down to 0.1 for P(b2|a3) and 0.2 for P(b3|a3).

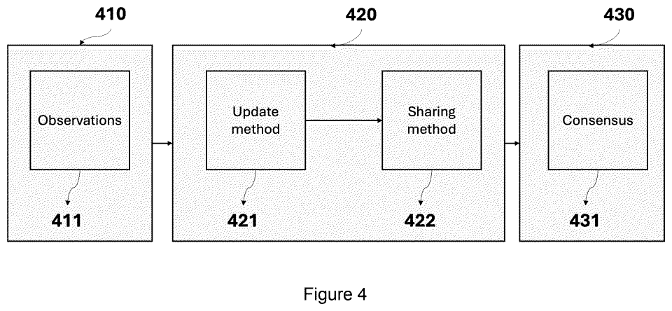

FIG. 4 depicts a flowchart of the method of interagent communication in probabilistic agents using factor graph document databases. An agent AG1 makes an observation (e.g., a box, b1) (411), which functions as the input data of the invention (410), and that can come from a sensor installed on the device controlled by the agent (e.g., a camera). The update method updates the counts in the conditional probability of the factor graph document database implemented by the agent, as per the method of adding counts presented in the description of FIG. 3. From a practical perspective, it will be appreciated that the factor graph document database will be pre-populated with data of particular entities. Thus, when we speak of different information or entities such as observed entities (e.g., boxes) and world state entities (e.g., locations in a warehouse) that are defined for the needs of a particular set of agents and tasks, we are referring to the needs of different agents within that set. Thus, the factor graph database defines the particular needs of the agents implementing it to accomplish a task. For instance, if the agent is a robot in a warehouse, the database should contain all the data relevant to the observations of items that can be made in the warehouse, and of all the warehouse states where those observations could be made. The sharing method combines the updated conditional probability parameter of the first agent AG1 with the prior probability parameter of the other agents (e.g., an agent AG2) using a method of matrix multiplication called Hadamard product as known in the arts (Horn, R. A., & Johnson, C. R. (2012). Matrix Analysis. Cambridge University Press.). The resulting matrix replaces the conditional probability parameter of all the agents (422). The inference method (421) and the sharing method (422) constitute the process of the invention (420). The output of the invention (430) is the consensus in the conditional probability parameters of all the agents achieved (431), such as described in referenced numeral 508 below.

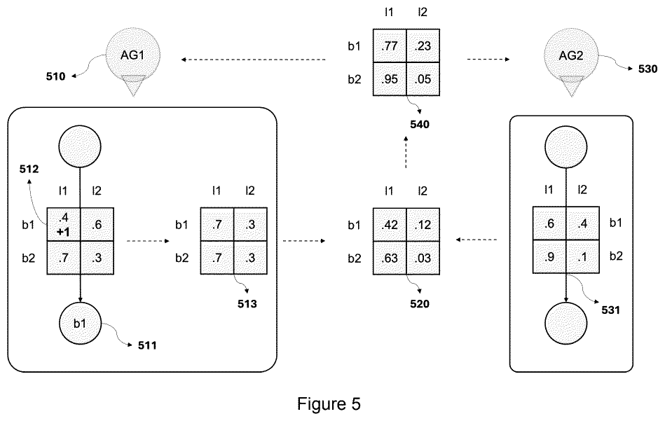

FIG. 5 depicts the process in reference numeral 420 of combining the update method and the sharing method to reach a consensus about the probabilistic structure of the environment in which agents have to perform a task. An input (511), may comprise an observation (e.g., box 1, b1) is observed by agent AG1 (510). Using a computer program, following the method of adding counts, +1 is added to the cell corresponding to the mapping of the observation (e.g., b1) of where the observation was made (e.g., location 11) (512). Using a computer program, the updated conditional probability parameter is normalized (e.g., 1.4/2=0.7 and 0.6/2=0.3) to make sure that the rows of the matrix sum to 1, as in the matrix reference numeral 513. The updated and normalized matrix of AG1 (513) is combined with the matrix of AG2 (530) as defined in reference numeral 531, using a computer program. The computation used to combine the matrices is a method of matrix multiplication called Hadamard product as known in the arts (Horn, R. A., & Johnson, C. R. (2012). Matrix Analysis. Cambridge University Press.). The resulting matrix in reference numeral 520 is then renormalized to make sure that its rows sum to 1, as in matrix reference numeral 540. The matrix in reference numeral 540 corresponds to the consensus that will then replace the matrices in agents AG1 (510) and AG2 (530), and constitute the output of the invention.

While the invention has been described with respect to particular embodiments and examples, it will be appreciated that the invention is not so limited but includes a broader set of implementation solutions as defined by the claims.

What is claimed is:

1. A method of interagent communication in probabilistic agents, comprising,
defining factor graph document databases for two or more probabilistic agents encoding one or more conditional probabilities, wherein the conditional probabilities are encoded in conditional probability vectors, matrices or tensors,
increasing counts in one or more cells of the vectors, matrices or tensors of the factor graph document database of one or more of the probabilistic agents when said one or more probabilistic agents receives new information,
renormalizing the conditional probability distributions in one or more of the factor graph document databases of the probabilistic agents,
combining the updated conditional probability vectors, matrices, or tensors of all of the factor graph document databases of the probabilistic agents by means of vector, matrix, or tensor multiplication operations,
replacing the conditional probability vectors, matrices, or tensors of each probabilistic agent with the new vectors, matrices, or tensors resulting from the multiplication operations.

2. A method of claim 1, wherein the new information corresponds to the observation of the co-occurrence of events mapped by the dimensions of a vector, matrix, or tensor of the factor graph document database by means of inputs coming from one or more physical or virtual sensors of one or more probabilistic agents.

3. A method of claim 1, wherein the renormalization of a probability distribution is achieved by summing over all the values of the cells of the vector, matrix or tensor forming the probability distribution, and by dividing each cell value by the sum of all the cells, or by an equivalent renormalization method.
